(19) United States
(12) Patent Application Publication
(10) Pub. No.: US 2018/0151136 A1
(43) Pub. Date: May 31, 2018

(54) DISPLAY DEVICE

(71) Applicant: Samsung Display Co., Ltd., Yongin-si (KR)

(72) Inventors: Keunchan OH, Hwaseong-si (KR); Donghan SONG, Hwaseong-si (KR); Sunkyu JOO, Suwon-si (KR)

(21) Appl. No.: 15/826,193

(22) Filed: Nov. 29, 2017

(30) Foreign Application Priority Data
Nov. 29, 2016 (KR) 10-2016-0160088

(51) Int. Cl. G09G 3/36

(52) U.S. Cl. CPC G09G 3/3614; G09G 3/3677; G09G 3/3688; G09G 3/2074; G09G 2300/0443; G09G 2320/0247; G09G 3/3607

(57) ABSTRACT

A display device capable of improving visibility and minimizing a flickering phenomenon is disclosed. The display device includes: first, second, and third pixels arranged in a matrix form and each including a first sub-pixel and a second sub-pixel; a first gate line extending along an upper side of the first sub-pixel in a plan view; a second gate line extending along a lower side of the second sub-pixel in the plan view; and a plurality of first, second, and third data lines crossing the first and second gate lines and arranged alternately along a row direction. The first sub-pixel included in each of the first, second, and third pixels is connected to the first gate line, the second sub-pixel included in each of the first, second, and third pixels is connected to the second gate line. The first sub-pixel included in the first pixel is connected to one first data line, the second sub-pixel included in the first pixel and the first sub-pixel included in the second pixel are connected to one second data line, the second sub-pixel included in the second pixel and the first sub-pixel included in the third pixel are connected to one third data line, and the second sub-pixel included in the third pixel is connected to another first data line.

### CROSS-REFERENCE TO RELATED APPLICATION

This application claims priority under 35 U.S.C. § 119 to Korean Patent Application No. 10-2016-0160088, filed on Nov. 29, 2016, in the Korean Intellectual Property Office (KIPO), the disclosure of which is incorporated by reference herein in its entirety.

### 1. TECHNICAL FIELD

Embodiments of the present disclosure relate to a display device, and more particularly, to a display device capable of improving visibility and minimizing a flickering phenomenon.

### 2. DISCUSSION OF RELATED ART

Display devices display an image using elements that emit light. In recent times, flat panel display (“FPD”) devices have been widely used as display devices. FPD devices may be classified into liquid crystal display (“LCD”) devices, organic light emitting diode (“OLED”) display devices, plasma display panel (“PDP”) devices, electrophoretic display devices, and the like based on a light emitting scheme thereof.

LCD devices are one of most widely used types of the FPD devices. A typical LCD device includes two substrates including electrodes formed thereon and a liquid crystal layer interposed therebetween. An electric field applied between the two electrodes causes liquid crystal molecules of the liquid crystal layer to be rearranged to control an amount of transmitted light in the LCD device.

In general, LCD devices have an issue of having lower lateral visibility compared to frontal visibility. In such a case, by dividing one pixel into two sub-pixels and driving the two sub-pixels by using respective switching elements, the lateral visibility of the LCD device may be improved.

In addition, liquid crystal materials included in the LCD device has an issue of being deteriorated as a result of repeated applications of an electric field having a same polarity. In order to substantially prevent the deterioration of the liquid crystal materials, a polarity of a pixel voltage that corresponds to a common voltage can be inverted when driving the LCD device. For example, in the case where a signal voltage of a positive polarity is charged in one pixel in a current frame, a signal voltage of a negative polarity can be charged therein in a succeeding frame.

To this end, various inversion driving schemes including, but not limited to, a frame inversion driving scheme, a line inversion driving scheme, a column inversion driving scheme, a dot inversion driving scheme, may be employed to drive the LCD device.

Such inversion driving schemes rely upon human eyes substantially simultaneously recognizing multiple pixels from a predetermined distance and thus, an average luminance value of the pixels in a predetermined area may be recognized to be substantially uniform to a viewer. Such inversion driving schemes may be appropriate in a general display environment when viewers may not feel uncomfortableness. However, when patterns corresponding to the inversion driving scheme are displayed, flickering may occur.

It is to be understood that this background section is intended to provide useful information for understanding the present disclosure. As such disclosed herein, the background section may include ideas, concepts, or recognitions that were not part of what was known or appreciated by those skilled in the pertinent art prior to a corresponding effective filing date of subject matter disclosed herein.

### SUMMARY

Embodiments of the present disclosure may be directed to a display device capable of improving visibility and minimizing a flickering phenomenon.

According to an exemplary embodiment, a display device includes: first, second, and third pixels arranged in a matrix form and each of the first, second, and third pixels including a first sub-pixel and a second sub-pixel; a first gate line extending along an upper side of the first sub-pixel in a plan view; a second gate line extending along a lower side of the second sub-pixel in the plan view; and a plurality of first, second, and third data lines crossing the first and second gate lines and arranged alternately along a row direction. The first sub-pixel included in each of the first, second, and third pixels is connected to the first gate line, the second sub-pixel included in each of the first, second, and third pixels is connected to the second gate line. The first sub-pixel included in the first pixel is connected to one first data line of the first data lines, the second sub-pixel included in the first pixel and the first sub-pixel included in the second pixel are connected to one second data line of the second data lines, the second sub-pixel included in the second pixel and the first sub-pixel included in the third pixel are connected to one third data line of the third data lines, and the second sub-pixel included in the third pixel is connected to another first data line of the first data lines.

The first sub-pixel and the second sub-pixel included in one of the first, second, and third pixels may respectively receive voltages having different polarities.

The first sub-pixels included in two adjacent ones of the first, second, and third pixels that may be adjacent to each other in the row direction receive voltages having different polarities, respectively.

The second sub-pixels included in two adjacent ones of the first, second, and third pixels that may be adjacent to each other in the row direction receive voltages having different polarities, respectively.

The first, second, and third pixels may be driven in a column inversion driving scheme.

The display device may further include a data driving unit configured to apply data voltages having different polarities to two adjacent ones of the plurality of first, second, and third data lines, respectively.

The display device may further include a gate driving unit connected to the first and second gate lines and configured to apply a gate signal.

The display device may further include a first gate driving unit connected to one of the first and second gate lines and configured to apply a gate signal and a second gate driving unit connected to the other of the first and second gate lines and configured to apply a gate signal.

The first and second sub-pixels included in one of the first, second, and third pixels may represent a substantially same color.

The first sub-pixel may have a planar area substantially equal to a planar area of the second sub-pixel.

The first sub-pixel may have a planar area larger than a planar area of the second sub-pixel.

The planar area of the first sub-pixel may be about 1.1 times to about 2.0 times the planar area of the second sub-pixel.

The foregoing is illustrative only and is not intended to be in any way limiting. In addition to the illustrative aspects, exemplary embodiments and features described above, further aspects, exemplary embodiments and features will become apparent by reference to the drawings and the following detailed description.

### BRIEF DESCRIPTION OF THE DRAWINGS

A more complete appreciation of the present disclosure will become more apparent by describing in detail exemplary embodiments thereof with reference to the accompanying drawings, wherein:

FIG. 1 is a block diagram illustrating a display device according to an exemplary embodiment;

FIG. 2A is a diagram schematically illustrating one pixel of FIG. 1;

FIG. 2B is an equivalent circuit diagram illustrating a first sub-pixel;

FIG. 3 is a diagram illustrating a polarity application of the display device according to a first exemplary embodiment;

FIG. 4A is a diagram illustrating a polarity application of the first pixel;

FIG. 4B is a diagram illustrating a polarity application of a pixel that displays red;

FIG. 5 is a diagram illustrating a polarity application of a display device according to a second exemplary embodiment;

FIG. 6 is a diagram illustrating a polarity application of a display device according to a third exemplary embodiment; and

FIG. 7 is a diagram illustrating a polarity application of a display device according to a fourth exemplary embodiment.

### DETAILED DESCRIPTION

Exemplary embodiments of the present disclosure will now be described more fully hereinafter with reference to the accompanying drawings. Although the present disclosure may be modified in various manners and have several exemplary embodiments, those exemplary embodiments are illustrated in the accompanying drawings and will be mainly described in the specification. However, the scope of the present disclosure is not limited to the exemplary embodiments and should be construed as including changes, equivalents, and substitutions included in the spirit and scope of the present disclosure.

In the drawings, thicknesses of a plurality of layers and areas may be illustrated in an enlarged manner for clarity and ease of description thereof. When a layer, area, or plate is referred to as being “on” another layer, area, or plate, it may be directly on the other layer, area, or plate, or one or more intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or one or more intervening layers, areas, or plates may be present therebetween. Conversely, when a layer, area, or plate is referred to as being “directly below” another layer, area, or plate, intervening layers, areas, or plates may be absent therebetween.

The spatially relative terms “below”, “beneath”, “lower”, “above”, “upper,” and the like may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

Throughout the specification, when an element is referred to as being “connected” to another element, the element can be “directly connected” to the other element, or “electrically connected” to the other element with one or more intervening elements interposed therebetween. It will be further understood that the terms “comprises,” “including,” “includes,” and/or “including,” when used herein, can specify the presence of stated features, integers, steps, operations, elements and/or components without precluding the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined, terms used herein (including technical and scientific terms) have the same meaning as commonly understood by those skilled in the art to which the present disclosure pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts that are not associated with the description may not be provided in order to specifically describe embodiments of the present disclosure, and like reference numerals refer to like elements throughout the specification.

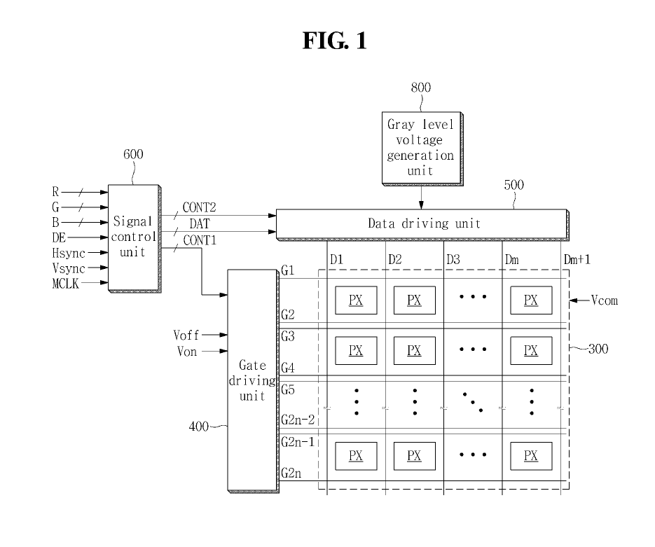

First, a display device according to an exemplary embodiment will be described with reference to FIGS. 1, 2A, 2B, 3, 4A, and 4B. Hereinafter, the display device according to an exemplary embodiment is an LCD device that employs a column inversion driving scheme, unless otherwise specified. The column inversion driving scheme may drive columns of the pixels in the LCD device with alternating polarities in successive frames.

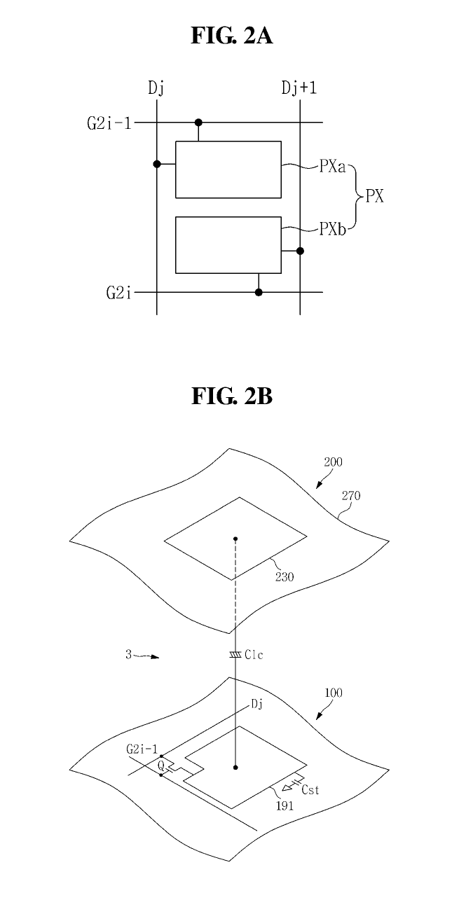

FIG. 1 is a block diagram illustrating a display device according to an exemplary embodiment, FIG. 2A is a diagram schematically illustrating one pixel of FIG. 1, and FIG. 2B is an equivalent circuit diagram illustrating a first sub-pixel.

Referring to FIGS. 1 and 2B, an LCD device according to the exemplary embodiment includes an LCD panel 300, a gate driving unit 400 and a data driving unit 500 connected to the LCD panel 300, a gray level voltage generation unit 800 connected to the data driving unit 500, and a signal control unit 600 controlling the elements described above.

The LCD panel 300 includes a plurality of signal lines G1 to G2n and D1 to Dm+1 and a plurality of pixels PX connected thereto. In such an exemplary embodiment, the plurality of pixels PX may be arranged in a matrix form. In addition, as illustrated in FIG. 2B, the LCD panel 300 includes lower and upper display panels 100 and 200 facing each other and a liquid crystal layer 3 interposed therebetween.

The signal lines G1 to G2n and D1 to Dm+1 include a plurality of gate lines G1 to G2n for transmitting gate signals and a plurality of data lines D1 to Dm+1 for transmitting data signals. Each of the plurality of gate lines G1 to G2n extends along a row direction and may be arranged in parallel with one another. Further, each of the plurality of data lines D1 to Dm+1 extends along a column direction and may be arranged in parallel with one another.

Each pixel PX includes first and second sub-pixels PXa and PXb, as illustrated in FIG. 2A. The first sub-pixel PXa is connected to a (2i−1)-th gate line G2i−1 and a j-th data line Dj, and the second sub-pixel PXb is connected to a 2i-th gate line G2i and a (j+1)-th data line Dj+1, where i=1, 2, . . . , n and j=1, 2, . . . , m.

Each of the first and second sub-pixels PXa and PXb includes a switching element Q, a liquid crystal capacitor Clc, and a storage capacitor Cst. For example, as illustrated in FIG. 2B, the first sub-pixel PXa connected to the (2i−1)-th gate line G2i−1 and the j-th data line Dj, i being 1, 2, . . . , n and j being 1, 2, . . . , m, may include a switching element Q connected to the signal lines G2i−1 and Dj, and a liquid crystal capacitor Clc and a storage capacitor Cst connected to the switching element Q. The storage capacitor Cst may be omitted in some embodiments.

The switching element Q is a three-terminal element such as a thin film transistor provided in the lower display panel 100. A control terminal of the switching element Q is connected to the gate line G2i−1, an input terminal of the switching element Q is connected to the data line Dj, and an output terminal of the switching element Q is connected to the liquid crystal capacitor Clc and the storage capacitor Cst.

The liquid crystal capacitor Clc has two terminals including a pixel electrode 191 disposed in the lower display panel 100 and a common electrode 270 disposed in the upper display panel 200. The liquid crystal layer 3 is interposed between the pixel electrode 191 and the common electrode 270 serving as a dielectric body. The pixel electrode 191 is connected to the switching element Q, and the common electrode 270 is formed over an entire surface of the upper display panel 200 to receive a common voltage Vcom. However, dissimilar to the embodiment illustrated in FIG. 2B, the common electrode 270 may be provided on the lower display panel 100, and in such an exemplary embodiment, at least one of the pixel electrode 191 and the common electrode 270 may be made linear or rod-shaped.

The storage capacitor Cst is formed by the pixel electrode 191 overlapping a separate signal line (not illustrated) that is provided at the lower display panel 100, with an insulating material disposed therebetween. However, exemplary embodiments are not limited thereto, and the storage capacitor Cst may be formed by the pixel electrode 191 overlapping an immediately above a previous gate line through the medium of an insulating material. The common voltage Vcom, for example, may be applied to the separate signal line.

In order to display a colored image, each pixel PX including the first and second sub-pixels PXa and PXb may uniquely display one of the primary colors (space division), or alternatively, may display the primary colors alternately over time (time division). Various colors may be recognized by the user based on the spatial and temporal sum of the primary colors. Examples of the primary colors may include red, green, and blue.

FIG. 2B shows an example of the space division in which the first sub-pixel PXa includes a color filter 230. The color filter 230 represents one of the primary colors and is disposed in an area of the upper display panel 200 corresponding to the pixel electrode 191. Dissimilar to the embodiment illustrated in FIG. 2B, the color filter 230 may be positioned above or below the pixel electrode 191 of the lower display panel 100. In addition, although not illustrated, the first and second sub-pixels PXa and PXb included in one pixel PX may respectively include color filters 230 having a substantially same primary color.

In addition, at least one polarizing layer (not illustrated) that polarizes light may be disposed on an outer surface of the LCD panel 300.

Referring back to FIG. 1, the gray level voltage generation unit 800 generates two gray level voltages (or reference gray level voltages) related to a transmittance of the pixel PX. One of the two gray level voltages has a positive value for the common voltage Vcom and the other of the two gray level voltages has a negative value for the common voltage Vcom.

The gate driving unit 400 is connected to the gate lines G1 to G2n of the LCD panel 300 and applies a gate signal including a gate-on voltage Von and a gate-off voltage Voff to the gate lines G1 to G2n.

The data driving unit 500 is connected to the data lines D1 to Dm+1 of the LCD panel 300. The data driving unit 500 selects a gray level voltage from the gray level voltage generation unit 800 and applies the gray level voltage as a data signal to the data lines D1 to Dm+1. However, in the case where the gray level voltage generation unit 800 provides only a predetermined number of reference gray level voltages, rather than providing voltages for all gray levels, the data driving unit 500 divides the predetermined number of reference gray level voltages to generate gray level voltages for all gray levels and selects the data signal from the generated gray level voltages.

The signal control unit 600 controls the gate driving unit 400 and the data driving unit 500.

Each of the driving devices 400, 500, 600, and 800 may be directly mounted on the LCD panel 300 in the form of at least one integrated circuit (“IC”) chip, may be mounted on a flexible printed circuit film (not illustrated) to be attached to the LCD panel 300 in the form of a tape carrier package (‘TCP,” not illustrated), or may be mounted on a separate printed circuit board (“PCB,” not illustrated). Alternatively, the driving devices 400, 500, 600 and 800 may be integrated into the LCD panel 300 together with the signal lines G1 to G2n and D1 to Dm+1 and the switching element Q. In addition, the driving devices 400, 500, 600, and 800 may be integrated into a single chip, and in such an exemplary embodiment, at least one of the driving devices 400, 500, 600, and 800 or at least one circuit element thereof may be located outside the single chip.

Hereinafter, the driving of the LCD device will be described in detail with reference to FIG. 1.

The signal control unit 600 receives, from an external graphic control unit (not illustrated), an input image signals R, G, and B and one or more input control signals for controlling the input image signals R, G, and B. Examples of the input control signals may include, but are not limited to, a vertical synchronization signal Vsync, a horizontal synchronization signal Hsync, a main clock MCLK, a data enable signal DE, and the like.

The signal control unit 600 suitably generates a gate control signal CONT1, a data control signal CONT2, and the like using the input image signals R, G, and B and the input control signals. Subsequently, the signal control unit 600 provides the gate control signal CONT1 to the gate driving unit 400 and provides the data control signal CONT2 and a treated digital image signal DAT to the data driving unit 500.

The gate control signal CONT1 includes a scan start signal instructing a start of scanning and at least one clock signal for controlling an output period of the gate-on voltage Von. The gate control signal CONT1 may further include an output enable signal that limits a duration of the gate-on voltage Von.

The data control signal CONT2 includes a horizontal synchronization start signal for instructing a start of transmission of image data for pixels PX of one row and a load signal, and a data clock signal for instructing application of a data signal to the data lines D1 to Dm+1. In addition, the data control signal CONT2 may further include an inversion signal for inverting a voltage polarity of the data signal for the common voltage Vcom.

According to the data control signal CONT2 applied from the signal control unit 600, the data driving unit 500 receives the digital image signal DAT for the pixels PX of one row, inverts the digital image signal DAT to an analog data signal by selecting a gray level voltage corresponding to each digital image signal DAT, and applies the analog data signal to a corresponding one of the data lines D1 to Dm+1.

The gate driving unit 400 applies the gate-on voltage Von to the gate lines G1 to G2n according to the gate control signal CONT1 received from the signal control unit 600 to turn on the switching element Q connected to the gate lines G1 to G2n. Then, the data signal is applied to the data lines D1 to Dm+1 and a corresponding one of the pixels PX through the turned-on switching element Q.

A difference between a voltage of the data signal applied to the pixel PX and the common voltage Vcom appears as a charging voltage of the liquid crystal capacitor Clc that is also referred to as a pixel voltage. Liquid crystal molecules have different arrangements according to a magnitude of the pixel voltage, and a polarization of a light passing through the liquid crystal layer 3 changes in accordance with the arrangement of the liquid crystal molecules. The change of the light polarization results in a change of light transmittance by a polarization layer (not shown) that may be attached to the LCD panel 300.

The above process is repeated for every horizontal period (also referred to as “1H” that is substantially equal to one period of the horizontal synchronization signal Hsync and the data enable signal DE). Accordingly, the gate-on voltage Von is sequentially applied to all of the gate lines G1 to G2n, and the data signal is applied to all of the pixels PX, such that an image of one frame is displayed.

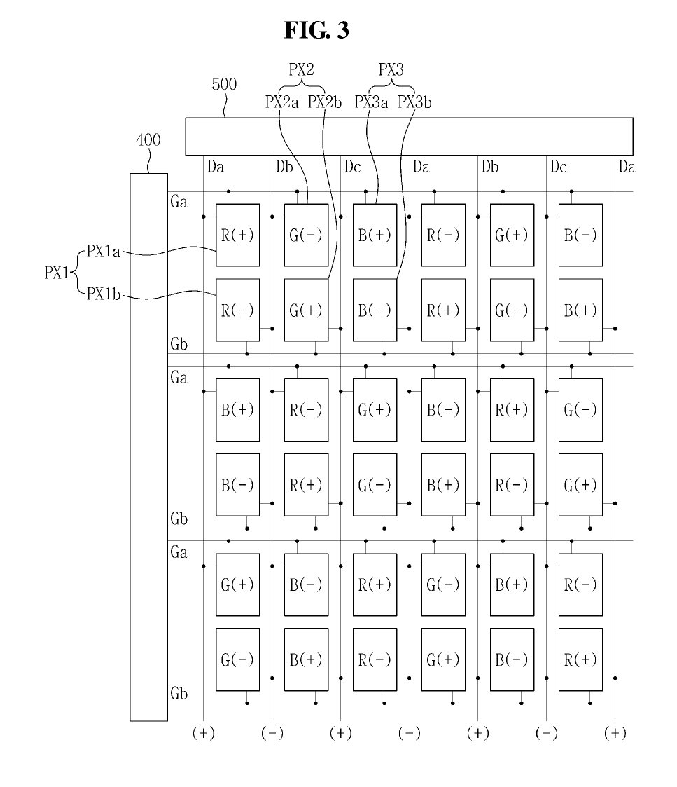

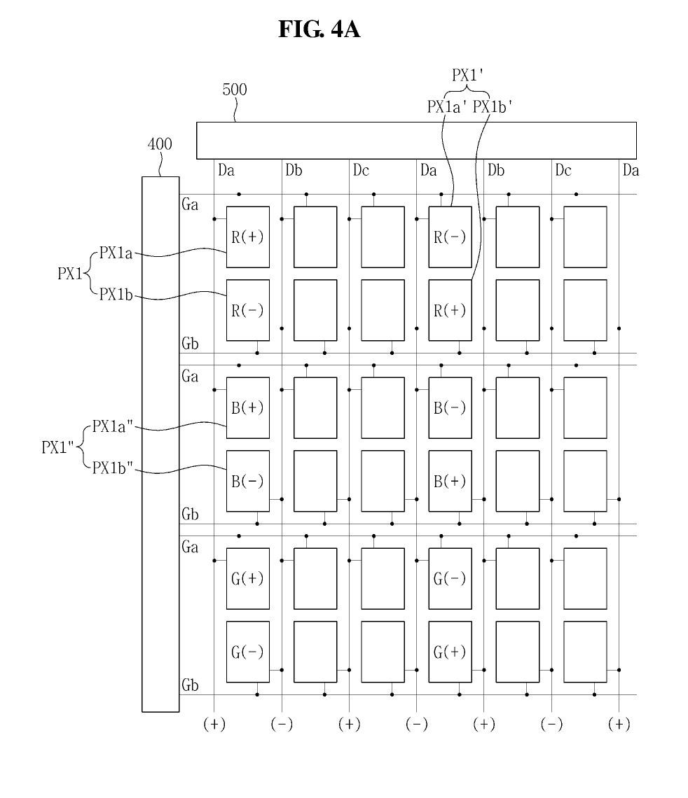

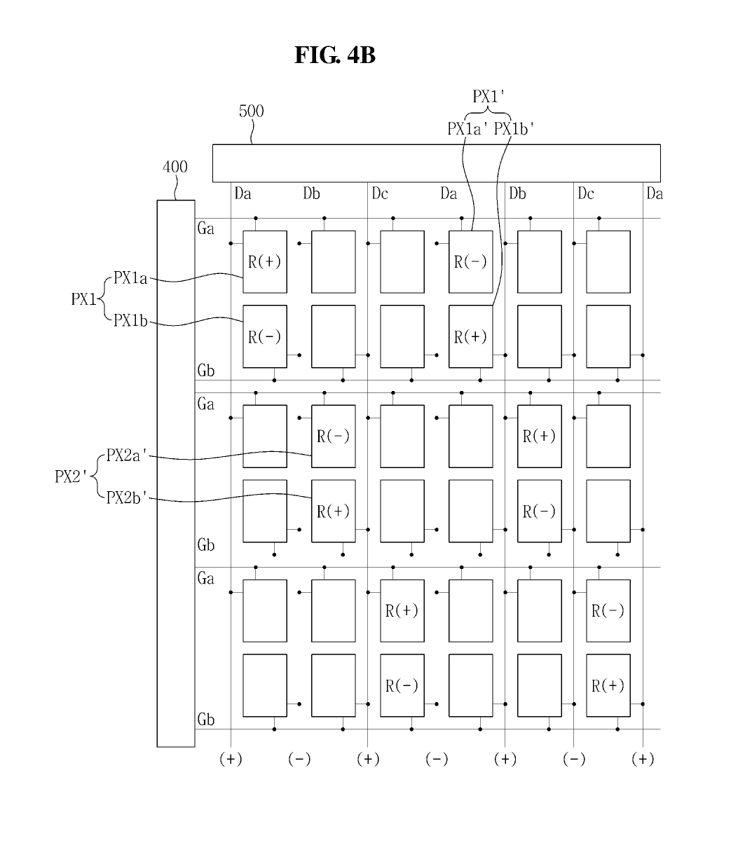

Hereinafter, the polarities of the data voltages applied to the first and second sub-pixels will be described in detail with reference to FIGS. 3, 4A, and 4B.

FIG. 3 is a diagram illustrating a polarity application of the display device according to a first exemplary embodiment, FIG. 4A is a diagram illustrating a polarity application of the first pixel, and FIG. 4B is a diagram illustrating a polarity application of a pixel that displays red. For convenience of explanation, six gate lines and seven data lines are shown in the drawings. In FIGS. 3, 4A, and 4B, a symbol R on a pixel means that the pixel is a red pixel displaying a red color, a symbol G on a pixel means that the pixel is a green pixel displaying a green color, and a symbol B on a pixel means that the pixel is a blue pixel displaying a blue color. However, exemplary embodiments are not limited thereto, and each pixel may display various colors.

Referring to FIG. 3, the display device includes first, second, and third pixels PX1, PX2, and PX3 arranged in a matrix form. The first, second, and third pixels PX1, PX2, and PX3 include first sub-pixels PX1a, PX2a, and PX3a and second sub-pixels PX1b, PX2b, and PX3b that are respectively arranged along the column direction. In such an exemplary embodiment, each of the first sub-pixels PX1a, PX2a, and PX3a and the second sub-pixels PX1b, PX2b, and PX3b may have a substantially equal planar area.

The first, second, and third pixels PX1, PX2 and PX3 including the first sub-pixels PX1a, PX2a, and PX3a and the second sub-pixels PX1b, PX2b, and PX3b are connected to a first gate line Ga, a second gate line Gb, a first data line Da, a second data line Db, and a third data line Dc.

As illustrated in FIG. 3, the first gate line Ga extends along an upper side of the first sub-pixels PX1a, PX2a, and PX3a on a plane, and the second gate line Gb extends along a lower side of the second sub-pixel PX1b, PX2b, PX3b on a plane. The plurality of first gate lines Ga and the plurality of second gate lines Gb may be arranged alternately along the column direction.

In such an exemplary embodiment, the first sub-pixels PX1a, PX2a, and PX3a included in the first, second, and third pixels PX1, PX2, and PX3 are all connected to the first gate line Ga, and the second sub-pixels PX1b, PX2b, and PX3b included in the first, second, and third pixels PX1, PX2, and PX3 are all connected to the second gate line Gb.

The first, second, and third data lines Da, Db, and Dc cross the first and second gate lines Ga and Gb and extend along the column direction. The plurality of first, second, and third data lines Da, Db and Dc may be arranged alternately along the row direction.

In such an exemplary embodiment, the first sub-pixel PX1a included in the first pixel PX1 is connected to one first data line Da; the second sub-pixel PX1b included in the first pixel PX1 and the first sub-pixel PX2a included in the second pixel PX2 are connected to the second data line Db; the second sub-pixel PX2b included in the second pixel PX2 and the first sub-pixel PX3a included in the third pixel PX3 are connected to the third data line Dc; and the second sub-pixel PX3b included in the third pixel PX3 is connected to another first data line Da.

As described above, the second sub-pixel PX1b included in the first pixel PX1 and the first sub-pixel PX2a included in the second pixel PX2 are connected to the same second data line Da, and the second sub-pixel PX2b included in the second pixel PX2 and the first sub-pixel PX3a included in the third pixel PX3 are connected to the same third data line Dc. As described above, the display device according to the first exemplary embodiment may drive each of the plurality of first and second sub-pixels independently without increasing the number of data lines within a limited area.

According to one embodiment, the display device including the first, second, and third pixels PX1, PX2 and PX3 may be driven in a column inversion driving scheme. The data driving unit 500 according to the first exemplary embodiment is depicted as applying a positive polarity voltage to odd-numbered data lines and a negative polarity voltage to even-numbered data lines. However, exemplary embodiments are not limited thereto. For example, the data driving unit 500 may apply a negative polarity voltage to the odd-numbered data lines and a positive polarity voltage to the even-numbered data lines.

Accordingly, first sub-pixels included in two pixels that are adjacent to each other in the row direction respectively may receive voltages having different polarities. For example, as illustrated in FIG. 3, the first sub-pixel PX1a included in the first pixel PX1 receives a positive polarity voltage, and the first sub-pixel PX2a included in the second pixel PX2 that is adjacent to the first pixel PX1 receives a negative polarity voltage.

In addition, second sub-pixels included in two pixels adjacent to each other in the column direction respectively may receive voltages having different polarities. For example, as illustrated in FIG. 3, the second sub-pixel PX2a included in the first pixel PX1 receives a negative polarity voltage, and the second sub-pixel PX2a included in the second pixel PX2 that is adjacent to the first pixel PX1 receives a positive polarity voltage.

According to the first exemplary embodiment, each pixel PX includes two independent sub-pixels PXa and PXb, such that visibility of the display device may be improved. In addition, because each of the sub-pixels PXa and PXb constitutes the above-described connection relationship under the column inversion driving scheme, the flickering phenomenon of the display device may be improved.

Hereinafter, the way of the display device according to the first exemplary embodiment improving the flickering phenomenon will be described in detail with reference to FIGS. 4A and 4B.

Referring to FIG. 4A, the first pixels PX1 and PX1′ that are adjacent to each other (and separated by the second and third pixels PX2 and PX3) in the row direction may respectively receive data voltages having different polarities, and the first pixels PX1 and PX1″ that are adjacent to each other in the column direction may receive data voltages having a same polarity. In such an exemplary embodiment, the first pixels PX1 and PX1′ that are adjacent to each other in the row direction may represent a substantially same color, and the first pixels PX1 and PX1″ that are adjacent to each other in the column direction may represent different colors.

More specifically, two first pixels PX1 and PX1′, e.g., one first pixel PX1 and another first pixel PX1′ that are adjacent to each other in the row direction may respectively receive data voltages having different polarities. For example, as illustrated in FIG. 4A, a first sub-pixel PX1a included in the first pixel PX1 receives a positive polarity voltage through one first data line Da, and a first sub-pixel PX1a′ included the first pixel PX1′ receives a negative polarity voltage through another first data line Da. In addition, a second sub-pixel PX1b included in the first pixel PX1 receives a negative polarity voltage through one second data line Db, and a second sub-pixel PX1b′ included in the first pixel PX1′ receives a positive polarity voltage through another second data line Db. According to the first exemplary embodiment, the two first pixels PX1 and PX1′ represent a red color.

In addition, two first pixels PX1 and PX1″, e.g., one first pixel PX1 and another first pixel PX1″ that are adjacent to each other in the column direction may receive data voltages having a same polarity. For example, as illustrated in FIG. 4A, a first sub-pixel PX1a included in the first pixel PX1 and a first sub-pixel PX1a″ included in the first pixel PX1″ receive a positive polarity voltage through a same first data line Da. In addition, a second sub-pixel PX1b included in the first pixel PX1 and a second sub-pixel PX1b″ included in the first pixel PX1″ receive a negative polarity voltage through a same second data line Db. According to the first exemplary embodiment, the first pixel PX1 represents a red color, and the first pixel PX1″ represents a blue color. However, exemplary embodiments are not limited thereto.

Similarly, second pixels PX2 adjacent to each other in the row direction may respectively receive data voltages having different polarities, and second pixels PX2 adjacent to each other in the column direction may receive data voltages having a same polarity. In such an exemplary embodiment, the second pixels PX2 adjacent to each other in the row direction may represent a substantially same color, and the second pixels PX2 adjacent to each other in the column direction may respectively represent different colors.

In addition, third pixels PX3 adjacent to each other in the row direction may respectively receive data voltages having different polarities, and third pixels PX3 adjacent to each other in the column direction may receive data voltages having a same polarity. In such an exemplary embodiment, the third pixels PX3 adjacent to each other in the row direction may represent a substantially same color, and the third pixels PX3 adjacent to each other in the column direction may respectively represent different colors.

Referring to FIG. 4B, two pixels PX that represent a red color and are adjacent to each other may respectively receive data voltages having different polarities.

More specifically, two first pixels PX1 and PX1′, e.g., one first pixel PX1 and another first pixel PX1′ that represent a red color and are adjacent to each other in the row direction may respectively receive data voltages having different polarities. For example, as illustrated in FIG. 4B, a first sub-pixel PX1a included in the first pixel PX1 receives a positive polarity voltage through one first data line Da, and a first sub-pixel PX1a′ included in the first pixel PX1′ receives a negative polarity voltage through another first data line Da. In addition, a second sub-pixel PX1b included in the first pixel PX1 receives a negative polarity voltage through one second data line Db, and a second sub-pixel PX1b′ included in the first pixel PX1′ receives a positive polarity voltage through another second data line Db.

In addition, the first pixel PX1 and the second pixel PX2′ that represent a red color and are adjacent to each other in an oblique direction may respectively receive data voltages having different polarities. For example, as illustrated in FIG. 4B, a first sub-pixel PX1a included in the first pixel PX1 receives a positive polarity voltage through a first data line Da, and a first sub-pixel PX2a′ included in the second pixel PX2′ receives a negative polarity voltage through a second data line Db. In addition, a second sub-pixel PX1b included in the first pixel PX1 receives a negative polarity voltage through the second data line Db, and a second sub-pixel PX2b′ included in the second pixel PX2′ receives a positive polarity voltage through a third data line Dc.

Similarly, two pixels PX that represent a green color and are adjacent to each other respectively may receive data voltages having different polarities, and two pixels PX that represent a blue color and are adjacent to each other respectively may receive data voltages having different polarities.

As such, in the display device according to the first exemplary embodiment, adjacent pixels that represent a substantially same color have different polarities, and thus the display device may improve the flickering phenomenon.

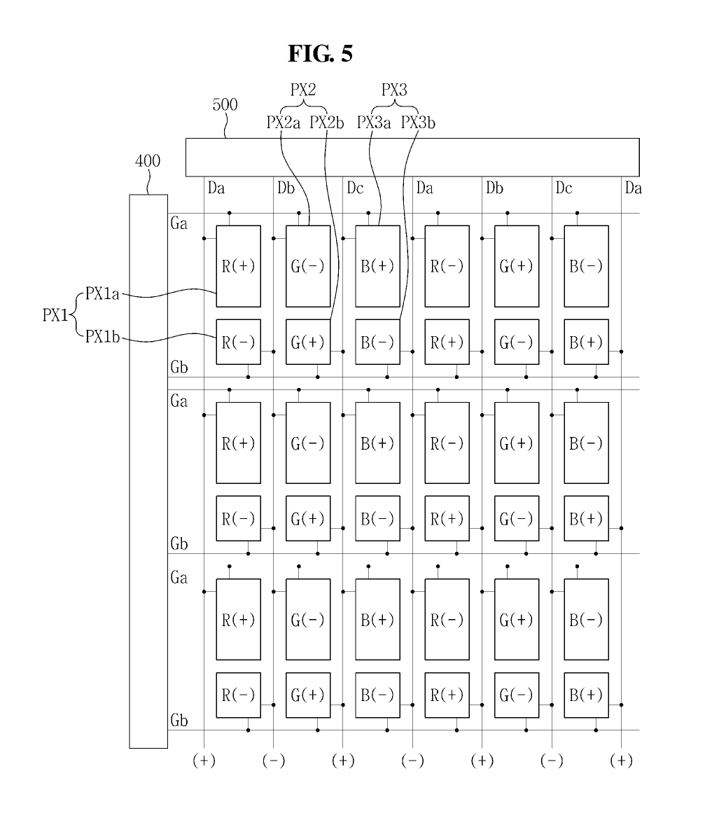

Hereinafter, a display device according to a second exemplary embodiment will be described with reference to FIG. 5. The descriptions of configuration that are substantially the same as those of the first exemplary embodiment may be omitted for convenience of explanation.

FIG. 5 is a diagram illustrating a polarity application of a display device according to the second exemplary embodiment.

Referring to FIG. 5, a display device includes first, second, and third pixels PX1, PX2, and PX3 arranged in a matrix form. The first, second, and third pixels PX1, PX2, and PX3 include first sub-pixels PX1a, PX2a, and PX3a and second sub-pixels PX1b, PX2b, and PX3b that are respectively arranged along the column direction.

In such an exemplary embodiment, the first sub-pixels PX1a, PX2a, and PX3a may each have a planar area larger than a planar area of each of the second sub-pixels PX1b, PX2b, and PX3b. For example, the planar area of each of the first sub-pixels PX1a, PX2a, and PX3a may be about 1.1 times to about 2.0 times the planar area of each of the second sub-pixel electrodes PX1b, PX2b, and PX3b.

Two first pixels PX1 adjacent to each other in the row direction respectively may receive data voltages having different polarities, and two first pixels PX1 adjacent to each other in the column direction may receive data voltages having a same polarity. In such an exemplary embodiment, all of the plurality of first pixels PX1 according to the second exemplary embodiment may represent a substantially same color. For example, as illustrated in FIG. 5, two first pixels PX1 adjacent to each other in the row direction may represent a red color, and two first pixels PX1 adjacent to each other in the column direction may represent a red color as well.

Similarly, two second pixels PX2 adjacent to each other in the row direction respectively may receive data voltages having different polarities, and two second pixels PX2 adjacent to each other in the column direction may receive data voltages having a same polarity. In such an exemplary embodiment, all of the plurality of second pixels PX2 according to the second exemplary embodiment may represent a substantially same color. For example, as illustrated in FIG. 5, two second pixels PX2 adjacent to each other in the row direction may represent a green color, and two second pixels PX2 adjacent to each other in the column direction may represent a green color as well.

In addition, two third pixels PX3 adjacent to each other in the row direction respectively may receive data voltages having different polarities, and two third pixels PX3 adjacent to each other in the column direction may receive data voltages having a same polarity. In such an exemplary embodiment, all of the plurality of third pixels PX3 according to the second exemplary embodiment may represent a substantially same color. For example, as illustrated in FIG. 5, two third pixels PX3 adjacent to each other in the row direction may represent a blue color, and two third pixels PX3 adjacent to each other in the column direction may represent a blue color as well.

Accordingly, the plurality of pixels PX connected to a same data line represent a substantially same color. According, a process of manufacturing the display device according to the second exemplary embodiment may be simplified.

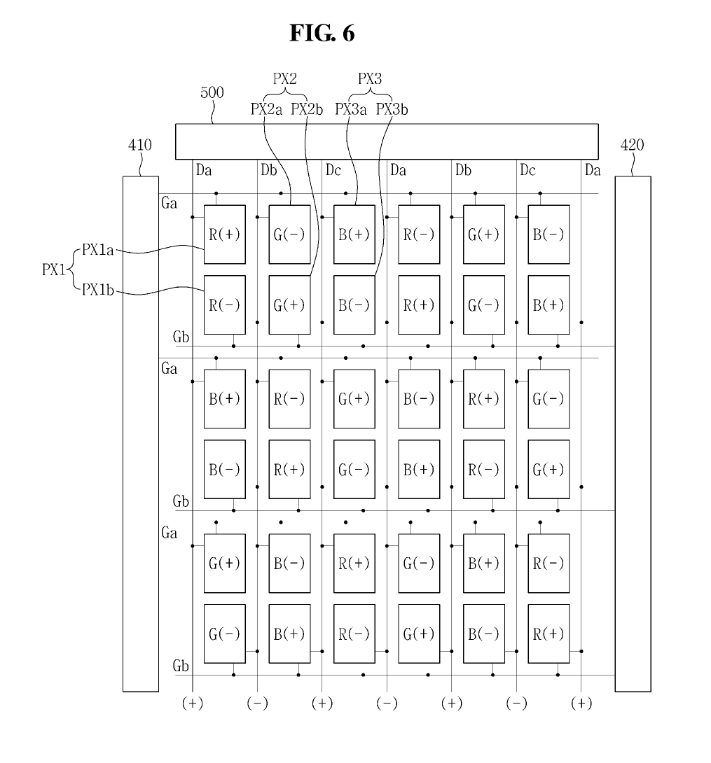

Hereinafter, a display device according to a third exemplary embodiment will be described with reference to FIG. 6.

FIG. 6 is a diagram illustrating a polarity application of a display device according to the third exemplary embodiment.

Referring to FIG. 6, a first gate line Ga extends along an upper side of first sub-pixels PX1a, PX2a, and PX3a on a plane, and a second gate line Gb extends along a lower side of second sub-pixels PX1b, PX2b, and PX3b on a plane. The plurality of first gate lines Ga and the plurality of second gate lines Gb may be arranged alternately along the column direction.

The display device according to the third exemplary embodiment includes a first gate driving unit 410 and a second gate driving unit 420. The first gate driving unit 410 is connected to the plurality of first gate lines Ga, and the second gate driving unit 420 is connected to the plurality of second gate lines Gb.

In such an exemplary embodiment, all of the first sub-pixels PX1a, PX2a, and PX3a included in the first, second, and third pixels PX1, PX2, and PX3 may be connected to the first gate line Ga, and all of the second sub-pixels PX1b, PX2b, and PX3b included in the first, second, and third pixels PX1, PX2, and PX3 may be connected to the second gate line Gb.

First, second, and third data lines Da, Db, and Dc cross the first and second gate lines Ga and Gb and extend along the column direction. The plurality of first, second, and third data lines Da, Db, and Dc may be arranged alternately in the row direction.

In such an exemplary embodiment, the first sub-pixel PX1a included in the first pixel PX1 is connected to one first data line Da; the second sub-pixel PX1b included in the first pixel PX1 and the first sub-pixel PX2a included in the second pixel PX2 are connected to the second data line Db; the second sub-pixel PX2b included in the second pixel PX2 and the first sub-pixel PX3a included in the third pixel PX3 are connected to the third data line Dc; and the second sub-pixel PX3b included in the third pixel PX3 is connected to another first data line Da.

Each pixel PX according to the third exemplary embodiment includes two independent sub-pixels PXa and PXb, such that visibility of the display device may be improved. In addition, because each of the sub-pixels PXa and PXb constitutes the above-described connection relationship under the column inversion driving scheme, the flickering phenomenon of the display device may be improved.

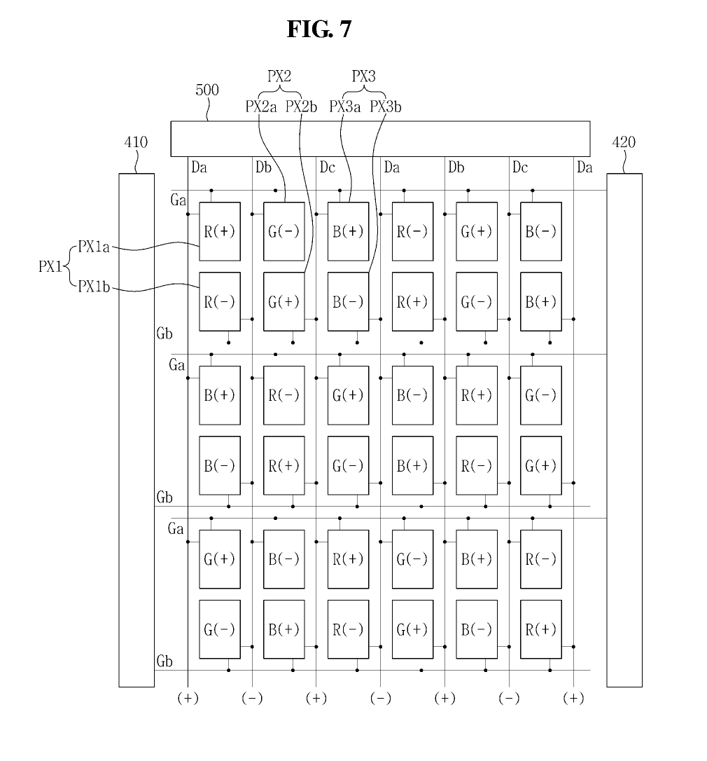

Hereinafter, a display device according to a fourth exemplary embodiment will be described with reference to FIG. 7.

FIG. 7 is a diagram illustrating a polarity application of a display device according to the fourth exemplary embodiment.

Referring to FIG. 7, a first gate line Ga extends along an upper side of first sub-pixels PX1a, PX2a, and PX3a on a plane, and a second gate line Gb extends along a lower side of second sub-pixels PX1b, PX2b, and PX3b on a plane. The plurality of first gate lines Ga and the plurality of second gate lines Gb may be arranged alternately along the column direction.

The display device according to the fourth exemplary embodiment includes a first gate driving unit 410 and a second gate driving unit 420. The first gate driving unit 410 is connected to the plurality of second gate lines Gb, and the second gate driving unit 420 is connected to the plurality of first gate lines Ga.

In such an exemplary embodiment, all of the first sub-pixels PX1a, PX2a, and PX3a included in the first, second, and third pixels PX1, PX2, and PX3 may be connected to the first gate line Ga, and all of the second sub-pixels PX1b, PX2b, and PX3b included in the first, second, and third pixels PX1, PX2, and PX3 may be connected to the second gate line Gb.

First, second, and third data lines Da, Db, and Dc cross the first and second gate lines Ga and Gb and extend along the column direction. The plurality of first, second, and third data lines Da, Db, and Dc may be arranged alternately in the row direction.

In such an exemplary embodiment, the first sub-pixel PX1a included in the first pixel PX1 is connected to one first data line Da; the second sub-pixel PX1b included in the first pixel PX1 and the first sub-pixel PX2a included in the second pixel PX2 are connected to the second data line Db; the second sub-pixel PX2b included in the second pixel PX2 and the first sub-pixel PX3a included in the third pixel PX3 are connected to the third data line Dc; and the second sub-pixel PX3b included in the third pixel PX3 is connected to another first data line Da.

Each pixel PX according to the fourth exemplary embodiment includes two independent sub-pixels PXa and PXb, such that visibility of the display device may be improved. In addition, because each of the sub-pixels PXa and PXb constitutes the above-described connection relationship under the column inversion driving scheme, the flickering phenomenon of the display device may be improved.

As set forth hereinabove, according to one or more exemplary embodiments, the display device may have improved visibility by including first and second sub-pixels in each pixel.

Further, according to one or more exemplary embodiments, the display device may improve the flickering phenomenon by applying a column inversion driving scheme.

While the present disclosure has been illustrated and described with reference to the exemplary embodiments thereof, it will be apparent to those of ordinary skill in the art that various changes in form and detail may be formed thereto without departing from the spirit and scope of the present disclosure.

What is claimed is:

1. A display device comprising:
first, second, and third pixels arranged in a matrix form and each of the first, second, and third pixels comprising a first sub-pixel and a second sub-pixel;
a first gate line extending along an upper side of the first sub-pixel in a plan view;
a second gate line extending along a lower side of the second sub-pixel in the plan view; and
a plurality of first, second, and third data lines crossing the first and second gate lines and arranged alternately along a row direction,
wherein the first sub-pixel included in each of the first, second, and third pixels is connected to the first gate line, the second sub-pixel included in each of the first, second, and third pixels is connected to the second gate line, and
wherein the first sub-pixel included in the first pixel is connected to one first data line of the first data lines, the second sub-pixel included in the first pixel and the first sub-pixel included in the second pixel are connected to one second data line of the second data lines, the second sub-pixel included in the second pixel and the first sub-pixel included in the third pixel are connected to one third data line of the third data lines, and the second sub-pixel included in the third pixel is connected to another first data line of the first data lines.

2. The display device of claim 1, wherein the first sub-pixel and the second sub-pixel included in one of the first, second, and third pixels respectively receive voltages having different polarities.

3. The display device of claim 1, wherein the first sub-pixels included in two adjacent ones of the first, second, and third pixels that are adjacent to each other in the row direction receive voltages having different polarities, respectively.

4. The display device of claim 1, wherein the second sub-pixels included in two adjacent ones of the first, second, and third pixels that are adjacent to each other in the row direction receive voltages having different polarities, respectively.

5. The display device of claim 1, wherein the first, second, and third pixels are driven in a column inversion driving scheme.

6. The display device of claim 5, further comprising a data driving unit configured to apply data voltages having different polarities to two adjacent ones of the plurality of first, second, and third data lines, respectively.

7. The display device of claim 1, further comprising a gate driving unit connected to the first and second gate lines and configured to apply a gate signal.

8. The display device of claim 1, further comprising a first gate driving unit connected to one of the first and second gate lines and configured to apply a gate signal and a second gate driving unit connected to the other of the first and second gate lines and configured to apply a gate signal.

9. The display device of claim 1, wherein the first and second sub-pixels included in one of the first, second, and third pixels represent a substantially same color.

10. The display device of claim 1, wherein the first sub-pixel has a planar area substantially equal to a planar area of the second sub-pixel.

11. The display device of claim 1, wherein the first sub-pixel has a planar area larger than a planar area of the second sub-pixel.

12. The display device of claim 11, wherein the planar area of the first sub-pixel is about 1.1 times to about 2.0 times the planar area of the second sub-pixel.
